(19) United States
(12) Patent Application Publication
(10) Pub. No.: US 2009/0257145 A1
(43) Pub. Date: Oct. 15, 2009

(54) CONTROL CIRCUIT AND INFORMATION STORAGE DEVICE

(75) Inventor: Isao TSUYAMA, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki (JP)

(21) Appl. No.: 12/406,307

(22) Filed: Mar. 18, 2009

(30) Foreign Application Priority Data
Mar. 18, 2008 (JP) 2008-069358

(51) Int. Cl. G11B 21/02

(52) U.S. Cl. 360/75; G9B/21.003

(57) ABSTRACT

A information storage device has a head slider having a flying height control mechanism and a recording and reproducing head, a low frequency superposed circuit that superimposes a low frequency voltage to a flying height adjustment signal to adjust the flying height of the head slider, and a polarity discrimination section that discriminates the polarity of the low frequency detection signal to the low frequency voltage through comparison of the low frequency voltage with the low frequency detection signal. When the polarity of the low frequency detection signal to the low frequency voltage is a negative polarity, the flying height adjustment signal is subtracted by a predetermined value, so that the flying height of the head slider is increased by the correspondence.

### CROSS-REFERENCE TO RELATED APPLICATIONS

This application is based upon and claims the benefit of priority of the prior Japanese Patent Application No. 2008-069358, filed on Mar. 18, 2008, the entire contents of which are incorporated herein by reference.

### FIELD

Example embodiments are related to a control circuit that controls a flying height control mechanism that controls the flying height of a recording and reproducing head for performing record and reproduction of information for a recording medium such as magnetic disks, from the recording medium, and an information storage device that has such a control circuit.

### BACKGROUND

In the field of the computer, a large amount of information comes to be handled daily, and a hard disk drive (HDD: Hard Disk Drive) is used as one of the information storage devices that perform record and reproduction for such a large amount of information. The HDD incorporates therein a magnetic disk that is a disk type of recording medium in which information is recorded in a magnetization state of a magnetic layer, and a recording and reproducing head for performing a recording of information onto the magnetic disk and a reproduction of information from the magnetic disk.

Incidentally, The recording and reproducing head records information by applying the magnetic field corresponding to the recording information to the magnetic disk, and reproduces information by detecting a slight magnetic field where the magnetization in the magnetic disk generates. The recording and reproducing head is installed in a head slider that is the block of the ceramic that consists of Al—TiC etc. The record and the reproduction are performed in the state that the head slider surfaces from the magnetic disk, that is, the recording and reproducing head surfaces from the magnetic disk. Here, the flying height from the magnetic disk of the recording and reproducing head at the time when information is recorded or reproduced might be changed by the influence of the flow of the air that flows between the surface of the magnetic disk that rotates at high speed and the head slider. At that time, the record and the reproduction of information deteriorate when the flying height becomes a flying height outside the tolerance by the change (For instance, refer to Japanese Laid-open Patent Publication No. 2004-199859).

In general, the shape of the head slider is often molded in such a way that the flying height from the magnetic disk is steady. However, the advance of the miniaturization of the head slider in recent years makes it difficult only in the device of shape to stabilize the flying height.

Then, in order to provide such a control that the flying height stabilizes within permissible limits, there is proposed a flying height control mechanism that maintains the flying height of the tolerance by properly spraying compress air between the surface of the magnetic disk and the head slider (For instance, refer to Japanese Laid-open Patent Publication No. sho.54-28606).

Further, there is proposed a flying height control mechanism that maintains the flying height of the tolerance in such a way that the thermal expansion is caused on the head slider by generation of heat of the heater set up in the head slider, so that the recording and reproducing head is projected properly toward the surface of the magnetic disk and returned (For instance, refer to Japanese Laid-open Patent Publication No. 2007-265516).

According to the technique as mentioned above, there is controlled the flying height from the magnetic disk of the recording and reproducing head that projects properly toward the surface of the magnetic disk by the thermal expansion of the head slider, but not the flying height from the magnetic disk of the main body of the head slider. In the following explanations, the flying height from the magnetic disk of the recording and reproducing head might be simply expressed, “flying height of the head slider”.

According to the conventional technique, the flying height from the magnetic disk of the head slider is maintained within a predetermined permissible limit, for example, in such a way that the flying height control mechanism causes the head slider to fly closely from the magnetic disk so that a signal strength of a reproduction signal with the recording and reproducing head becomes a reference signal strength corresponding to a predetermined reference flying height. Basically, the larger the flying height from the magnetic disk of the magnetic disk of the head slider, that is, the flying height from the magnetic disk of the recording and reproducing head, the smaller the signal strength of the reproduction signal, and the smaller the flying height, the more greatly the signal strength of the reproduction signal. Therefore, according to the conventional processing as mentioned above, the head slider is brought close to the magnetic disk when the signal strength of the reproduction signal is smaller than that of the reference signal strength, and the head slider is kept away from the magnetic disk when the signal strength of the reproduction signal is larger than that of the reference signal strength.

It is known that there will occur a phenomenon addressed as a demagnetization wherein while the recording and reproducing head generates a magnetic field at the reproduction of information as well as the recording of information, when the head slider is too much near the magnetic disk, in other words, the recording and reproducing head approaches too much the recording medium such as magnetic disks, the magnetic field generated by the recording medium such as magnetic disks is negated by the magnetic field generated from the recording and reproducing head, so that the signal strength of the reproduction signal is degreased. According to the conventional processing as mentioned above, when such demagnetization occurs, the flying height control mechanism brings the head slider close to the recording medium further though the recording and reproducing head approaches the recording medium too much. As a result, the recording and reproducing head approaches the recording medium too much abnormally, and thus there is a possibility of occurrence of trouble such that the head slider collides with the magnetic disk.

Additional objects and advantages of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### SUMMARY

A control circuit according to an aspect of the present embodiment is a control circuit for flying height of a head slider having a flying height control mechanism and a recording and reproducing head, the control circuit includes:

a signal strength detection section that detects strength of a reproduction signal of the recording and reproducing head;

a low frequency oscillation section that superimposes a low frequency to the head slider;

a limit flying height judgment section that judges whether or not a flying height of the head slider has reached a limit flying height, through comparison of a low frequency overlay signal where the low frequency is superposed to the head slider and a low frequency overlay signal obtained from a reproduction signal of the recording and reproducing head when the low frequency is superposed to the head slider;

a comparator that computes an output strength difference between a signal strength output from the signal strength detection section and a reference signal strength on a reference flying height; and

a flying height control section that receives the output strength difference from the comparator and the limit flying height from the limit flying height judgment section, and controls the flying height of the head slider with the flying height control mechanism to the reference flying height in accordance with the output strength difference and the limit flying height.

An information storage device according to another aspect of the present invention includes:

a head slider having a flying height control mechanism and a recording and reproducing head;

a recording medium in which information is recorded and reproduced by the recording and reproducing head; and

a control circuit comprising: a signal strength detection section that detects strength of a reproduction signal of the recording and reproducing head; a low frequency oscillation section that superimposes a low frequency to the head slider; a limit flying height judgment section that determines a limit flying height of the head slider through comparison of a low frequency overlay signal where the low frequency is superposed to the head slider and a low frequency overlay signal obtained from a reproduction signal of the recording and reproducing head when the low frequency is superposed to the head slider; a comparator that computes an output strength difference between a signal strength output from the signal strength detection section and a reference signal strength on a reference flying height; and a flying height control section that receives the output strength difference from the comparator and the limit flying height from the limit flying height judgment section, and controls the flying height of the head slider with the flying height control mechanism to the reference flying height in accordance with the output strength difference and the limit flying height.

Other features and advantages of embodiments of the invention are apparent from the detailed specification and, thus, are intended to fall within the scope of the appended claims. Further, because numerous modifications and changes will be apparent to those skilled in the art based on the description herein, it is not desired to limit the embodiments of the invention to the exact construction and operation illustrated and described, and accordingly all suitable modifications and equivalents are included.

### BRIEF DESCRIPTION OF THE DRAWINGS

FIG. 1 is a typical block diagram of a first embodiment of an information storage device;

FIG. 2 is an explanatory view useful for understanding demagnetization;

FIG. 3 is a view illustrating details of a low frequency circuit 120;

FIG. 4A and FIG. 4A are each an explanatory view useful for understanding polarities which are discriminated by a polarity discrimination circuit 106;

FIG. 5 is a view illustrating details of a flying height regulation circuit 110 which is illustrated in FIG. 1 with a block;

FIG. 6 is a view illustrating details of signal strength detection means 112;

FIG. 7 is a typical block diagram of a second embodiment of a control circuit and an information storage device;

FIG. 8 is a flowchart useful for understanding renewal processing of a reference voltage VSET based on a code error rate of a reproduction signal;

FIG. 9 is a typical block diagram of a third embodiment of a control circuit and an information storage device;

FIG. 10 is a view illustrating details of temporary storage means;

FIG. 11 is a typical block diagram of a fourth embodiment of a control circuit and an information storage device;

FIG. 12 is a circuit diagram of the adjustment amount watch means 411 and the adjustment amount limitation means 412;

FIG. 13 is a typical block diagram of a fifth embodiment of a control circuit and an information storage device;

FIG. 14 is a view illustrating details of a flying height adjustment circuit; and

FIG. 15 is a typical block diagram useful for understanding variation of resistivity in a flying height adjustment head 502 to the magnetic field.

### DESCRIPTION OF EXAMPLE EMBODIMENT(S)

Embodiments of the present invention will be described with reference to the accompanying drawings.

First of all, the first embodiment of a control circuit and an information storage device will be explained.

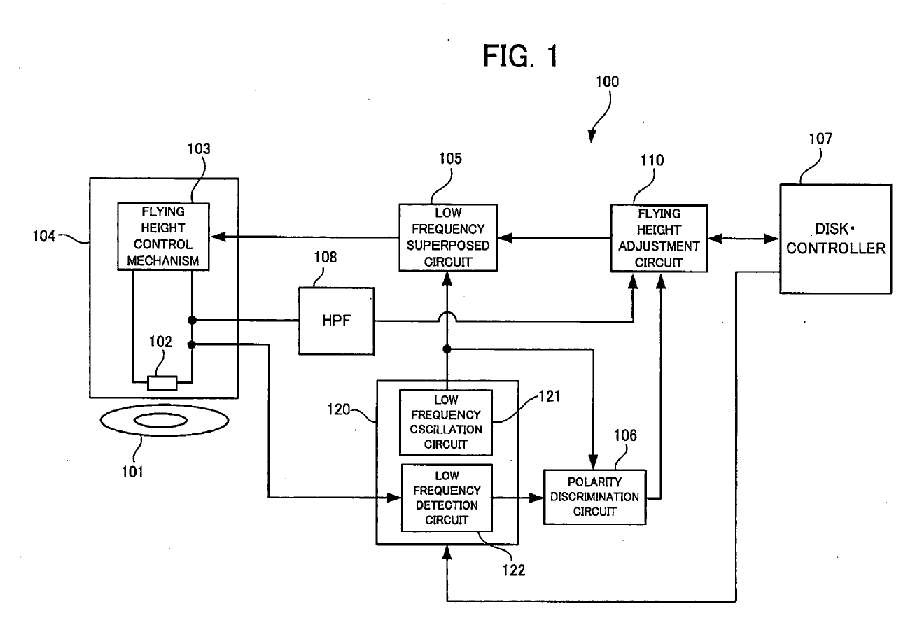

FIG. 1 is a typical block diagram of a first embodiment of an information storage device.

An information storage device 100 illustrated in FIG. 1 is provided with a magnetic disk 101 that is disk recording medium where information is recorded with magnetization of a magnetic layer, a head slider 104 where a recording and reproducing head 102 and a flying height control mechanism 103 are installed, a low frequency superposed circuit 105, a polarity discrimination circuit 106, a disk controller 107 that performs general control in the information storage device 100, a high-pass filter 108, a flying height adjustment circuit 110, and a low frequency circuit 120 having a low frequency oscillation circuit 121 and a low frequency detection circuit 122. The magnetic disk 101 corresponds to an example of the recording medium in the basic form of the control circuit and the information storage device as mentioned above. The head slider 104 corresponds to an example of the head slider in the basic form of the control circuit and the information storage device. The flying height adjustment circuit 110 corresponds to an example of the control circuit in the basic form of the information storage device as well as the first embodiment of the control circuit. The recording and reproducing head 102 corresponds to an example of the recording and reproducing head in the basic form of the control circuit and the information storage device. The flying height control mechanism 103 corresponds to an example of the flying height control mechanism in the basic form of the control circuit and the information storage device. The low frequency superposed circuit 105 corresponds to an example of the low frequency oscillation section in the basic form of the control circuit and the information storage device. The polarity discrimination circuit 106 corresponds to an example of the limit flying height judgment section in the basic form of the control circuit and the information storage device.

The recording and reproducing head 102 consists strictly of a recording head that records information by applying the magnetic field according to the recording information to the magnetic disk 101, and the reproducing head that reproduces information by detecting a slight magnetic field where the magnetization in the magnetic disk 101 generates. The recording and reproducing head 102 performs recording and reproduction in a state that it has surfaced from the magnetic disk 101. The recording and reproducing head 102 corresponds to an example of the recording and reproducing head in the basic form of the control circuit.

The flying height control mechanism 103 is composed of a heater for heating which is installed near the recording and reproducing head 102 in the head slider 104, and a supply circuit where the current is supplied to the heater. The supply circuit is adapted to receive a voltage signal that indicates the magnitude of the current to be supplied to the heater, from the flying height adjustment circuit 110 through the low frequency superposed circuit 105. The supply circuit supplies to the heater the current of the magnitude corresponding to the voltage signal, so that the heater generates heat by the calorific value corresponding to the magnitude of the supplied current. The generation of the heat causes the thermal expansion on the head slider 104, so that the flying height of head slider 104 to the magnetic disk 101 decreases. In a word, the flying height control mechanism 103 adjusts the flying height to the magnetic disk 101 of the head slider 104 by causing the thermal expansion on the head slider 104 by the amount of the movement corresponding to the voltage signal input from the flying height adjustment circuit 110. In the following, because the voltage signal from the flying height adjustment circuit 110 is a signal that directs the flying height control mechanism 103 the amount of the adjustment of the flying height, the voltage signal is referred to as a flying height adjustment signal. By such working of the flying height control mechanism 103, the recording and reproducing head 102 is brought close to the surface of magnetic disk 101 by only the amount of the movement corresponding to the thermal expansion of the head slider 104.

The flying height adjustment circuit 110 is a circuit that determines a flying height adjustment signal based on strength of the reproduction signal on the recording and reproducing head 102 and outputs the flying height adjustment signal to the flying height adjustment mechanism 103. The explanation here stops to the explanation of the outline of the flying height adjustment circuit 110, and will describe details of the flying height adjustment circuit 110 later.

According to the present embodiment, when the heater of the flying height control mechanism 103 is in the state of non-generation of heat, the head slider 104 leaves enough from the surface of magnetic disk 101, and as a result, the recording and reproducing head 102 is away enough from the surface of magnetic disk 101. In the flying height adjustment circuit 110, the flying height adjustment signal to the flying height adjustment mechanism 103 is determined by increasing and decreasing based on strength of the reproduction signal the flying height adjustment signal of default in which the flying height of the head slider 104 from the surface of the magnetic disk 101 becomes a prescribed reference flying height in the design. In principle, strength of the reproduction signal decreases when the recording and reproducing head 102 goes away from magnetic disk 101, and oppositely strength of the reproduction signal increases when the recording and reproducing head 102 approaches the magnetic disk 101. Therefore, basically, when strength of the reproduction signal is lower than the reference strength where the reproduction signal that should have when the flying height is the reference flying height, the flying height adjustment circuit 110 enlarges the flying height adjustment signal, and oppositely flying height adjustment circuit 110 reduces the flying height adjustment signal when strength of the reproduction signal is higher than the reference strength. According to the present embodiment, basically, the flying height from the magnetic disk 101 of the head slider 104 is maintained in the tolerance that doesn't influence the record and the reproduction of information including the reference flying height by adjusting such a flying height adjustment signal in the flying height adjustment circuit 110.

The recording and reproducing head 102 generates the magnetic field at the time when information is reproduced as well as the time when information is recorded. However, when the recording and reproducing head 102 approaches the magnetic disk 101 too much, the magnetic field generated from the magnetic disk 101 is denied by the magnetic field generated from the recording and reproducing head 102, so that there occurs the phenomenon referred to as demagnetization in which the signal strength of the reproduction signal rather decreases. In the state that the demagnetization occurs, strength of the reproduction signal decreases more and more when the flying height adjustment signal is enlarged by the reason that strength of the reproduction signal is lower than the reference strength, so that the head slider 104 is brought close to the magnetic disk 101.

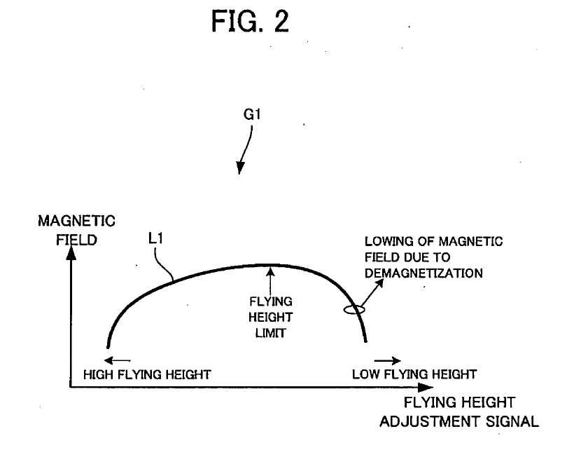

FIG. 2 is an explanatory view useful for understanding demagnetization.

FIG. 2 illustrates a graph G1 where a horizontal axis denotes the flying height adjustment signal, and a vertical axis denotes strength of the magnetic field from the magnetic disk 101 that is detected by the recording and reproducing head 102. In the graph G1, there is illustrated line L1 that indicates the change in magnetic field strength to the change in the flying height adjustment signal. The larger flying height adjustment signal the flying height of the head slider 104 more decreases by the thermal expansion, and, as a result, the recording and reproducing head 102 is brought close to the magnetic disk 101. Strength of the magnetic field detected by the recording and reproducing head 102 can be considered to be strength of the reproduction signal as it is. In a word, line L1 of FIG. 2 illustrates the change in strength of the reproduction signal to the change in the flying height from the magnetic disk 101 of the head slider 104, that is, the change in the flying height from the magnetic disk 101 of the recording and reproducing head 102.

As seen from the curve of the left side in the figure in line L1, basically, strength of the reproduction signal increases when the flying height decreases. However, when the flying height decreases exceeding a prescribed critical point, strength of the reproduction signal decreases by the demagnetization as decreasing in the flying height. In a word, the change in strength of the reproduction signal reverses at time when the flying height is more greatly than the flying height critical point, so that the demagnetization is not generated, and at time when the flying height is smaller than the flying height critical point, so that the demagnetization is generated.

According to the present embodiment, the generation of the demagnetization is detected paying attention to the difference of the change in strength of the reproduction signal at the time of the demagnetization non-generation and the demagnetization generation. The generation of the demagnetization is detected with the low frequency circuit 120, the low frequency superposed circuit 105, and the polarity discrimination circuit 106 in the manner as will be explained as follows.

In the detection of the generation of the demagnetization, first of all, the low frequency oscillation circuit 121 of the low frequency circuit 120 generates an alternating voltage (low frequency voltage) of low frequencies in which the thermal expansion in the head slider 104 is able to respond, and the low frequency superposed circuit 105 superimposes the low frequency voltage to the flying height adjustment signal output from the flying height adjustment circuit 110. The overlay of the low frequency voltage is carried out when the recording and reproducing head 102 reproduces information. The overlay of the low frequency voltage causes the flying height from the surface of the magnetic disk 101 of the head slider 104 to change gradually in the low frequency of the low frequency voltage. According to the present embodiment, when assuming that the flying height changes centering on the reference flying height in accordance with the low frequency voltage, the amplitude of the low frequency voltage is an amplitude in which the changing flying height becomes the tolerance that doesn't influence the record and the reproduction of information. In the change of the flying height by the overlay of the low frequency voltage, strength of the reproduction signal obtained with the recording and reproducing head 102 comes to have the change element that changes with the same frequency as the low frequency. In the detection of the generation of the demagnetization, the change element is detected with the low frequency detection circuit 122 of the low frequency circuit 120.

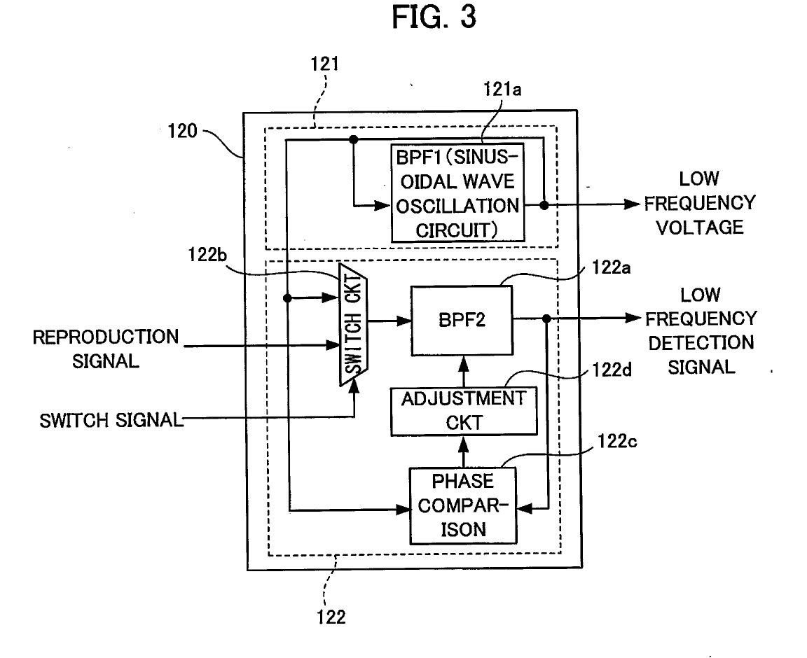

FIG. 3 is a view illustrating details of a low frequency circuit 120.

As illustrated in FIG. 3, the low frequency oscillation circuit 121 of the low frequency circuit 120 is implemented in such a way that the output and the input of a prescribed band-pass filter 121a are coupled with one another so as to cause the band-pass filter 121a to bring about the resonance. The low frequency voltage caused by the resonance is transferred to the low frequency superposed circuit 105 and the polarity discrimination circuit 106.

The low frequency detection circuit 122 of the low frequency circuit 120 has an equal band-pass filter 122a to the band-pass filter 121a of the low frequency oscillation circuit 121. The reproduction signal is input to the band-pass filter 122a when information is reproduced, and the band-pass filter 122a extracts the change element of the same low frequency as the above-mentioned low frequency voltage from the reproduction signal. The change element of thus extracted low frequency (low frequency detection signal) is transferred to the polarity discrimination circuit 106.

The polarity discrimination circuit 106 discriminates the polarity of the low frequency detection signal to the low frequency voltage as will be described later. In order that the polarity is discriminated excellently, it is preferable that the state of the circuit of the band-pass filter 122a of the low frequency detection circuit 122 is in the state of the circuit in which the low frequency voltage is output as the low frequency detection signal as it is without shift of the phase, when the low frequency voltage is input as it is.

According to the present embodiment, the adjustment of the state of the circuit of the band-pass filter 122a is executed in accordance with the instruction from the disk controller 107 in a prescribed timing. The low frequency detection circuit 122 has: a switch circuit 122b that receives a switch signal from the disk controller 107, and switches input to the band-pass filter 122a between the reproduction signal and the low frequency voltage; a phase comparison circuit 122c that compares a phase of a low frequency voltage where the low frequency voltage is input to the band-pass filter 122a with a phase of the low frequency detection signal and detects a phase shift between both the phases; and an adjustment circuit 122d that adjusts the state of the circuit of the band-pass filter 122a to negate the phase shift detected by the phase comparison circuit 122c. By these circuits' working, the band-pass filter 122a of the low frequency detection circuit 122 comes to extract the low frequency detection signal from the reproduction signal preferable when information is reproduced and to output it. In the detection of the generation of the demagnetization, as explained above, the polarity distinction circuit 106 discriminates the polarity of the low frequency detection signal to the low frequency voltage output from the low frequency circuit 120.

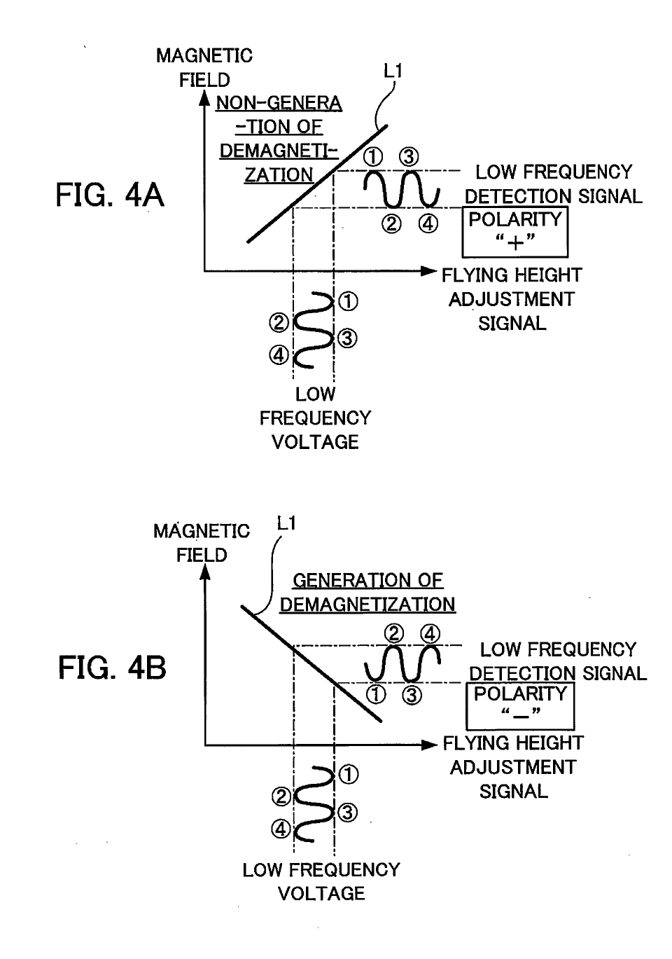

FIG. 4A and FIG. 4A are each an explanatory view useful for understanding polarities which are discriminated by a polarity discrimination circuit 106.

FIG. 4A illustrates an enlarged view of a part in graph G1 illustrated in FIG. 2 at the time of non-generation of the demagnetization where the magnitude of the flying height adjustment signal (voltage value) is lower than the voltage value corresponding to the flying height critical point. FIG. 4B illustrates an enlarged view of a part in graph G1 illustrated in FIG. 2 at the time of generation of the demagnetization where the magnitude of the flying height adjustment signal (voltage value) is higher than the voltage value corresponding to the flying height critical point.

As mentioned above, at the time when the demagnetization is non-generated, strength of the magnetic field detected by the recording and reproducing head 102, that is, strength of the reproduction signal increases as the flying height adjustment signal increases, that is, the flying height decreases. As a result, as illustrated in FIG. 4A, the voltage rise in the low frequency voltage superimposed to the flying height adjustment signal corresponds to the strength rise in the low frequency detection signal, and the voltage decrease in the low frequency voltage corresponds to the strength decrease in the low frequency detection signal. Thus, the polarity of the low frequency detection signal to the low frequency voltage becomes a positive polarity.

On the other hand, at the time of generating of the demagnetization, contrary to non-generating of the demagnetization, strength of the magnetic field detected by the recording and reproducing head 102, that is, strength of the reproduction signal decreases as the flying height decreases. As a result, as illustrated in FIG. 4B, the voltage rise in the low frequency voltage corresponds to the strength decrease in the low frequency detection signal, and the voltage decrease in the low frequency voltage corresponds to the strength rise in the low frequency detection signal. Thus, the polarity of the low frequency detection signal to the low frequency voltage becomes a negative polarity.

The low frequency voltage and the low frequency detection signal are input to the polarity discrimination circuit 106 of FIG. 1, and the polarity discrimination circuit 106 compares both so that the polarity is discriminated. And, the polarity discrimination circuit 106 transfers the discriminated polarity to the flying height adjustment circuit 110.

Next, there will be explained details of the flying height adjustment circuit 110.

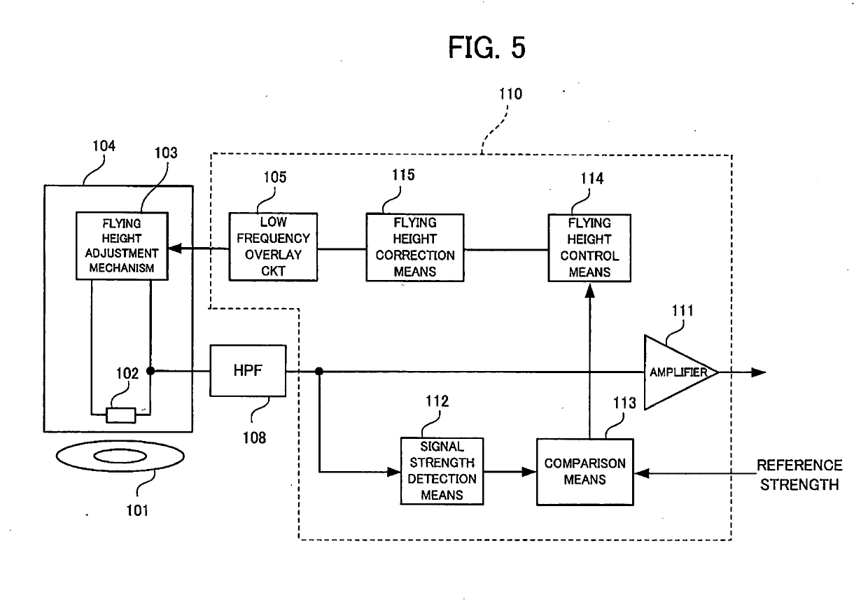

FIG. 5 is a view illustrating details of a flying height regulation circuit 110 which is illustrated in FIG. 1 with a block.

FIG. 5 also illustrates the magnetic disk 101, the head slider 104, the low frequency superposed circuit 105, and the high-pass filter 108, which are illustrated in FIG. 1.

As mentioned above, the reproduction signal obtained by the recording and reproducing head 102 includes the low frequency detection signal corresponding to the low frequency voltage that is superimposed by the low frequency overlay circuit 105. According to the present embodiment, the low frequency detection signal is excluded from the reproduction signal with the high-pass filter 108. And, the flying height adjustment circuit 110 receives the reproduction signal from which the low frequency detection signal is excluded.

The flying height adjustment circuit 110 has an amplifier 111 that amplifies the reproduction signal. The reproduction signal amplified with the amplifier 111 is sent to the disk controller 107 to perform the processing such as decoding for the reproduction signal.

The flying height adjustment circuit 110 further has signal strength detection means 112 to detect strength of the input reproduction signal. The signal strength detection means 112 corresponds to one example of the signal strength detection section in a basic form of the control circuit and the information storage device.

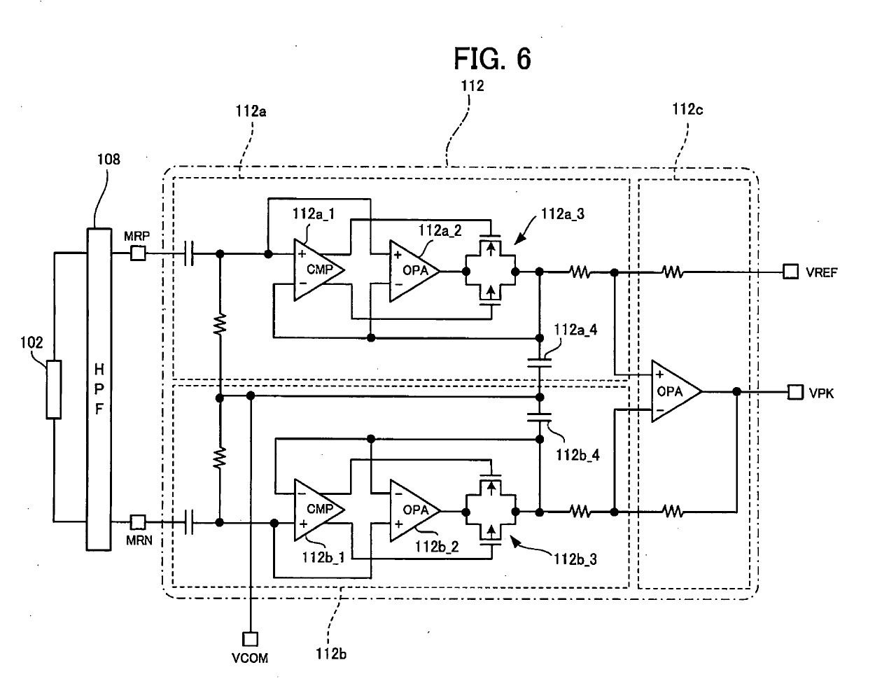

FIG. 6 is a circuit diagram illustrating details of the signal strength detection means 112.

The reproduction signal, which is obtained with the recording and reproduction head 102 and is excluded in the low frequency detection signal with the high-pass filter 108, is a signal that has two voltage levels corresponding to two states of “high” and “low”. The signal strength detection means 112 of the circuit diagram of FIG. 6 is a circuit that outputs the voltage obtained with all wave rectification and smoothing to such a reproduction signal in form of strength VPK of the reproduction signal (reproduction signal strength). The signal strength detection means 112 has: a high side peak detection circuit 112a that detects the peak value at the voltage level on a high side to a certain operational point potential VCOM; a low side peak detection circuit 112b that detects the peak value at the voltage level on a low side to the operational point potential VCOM; and an addition circuit 112c wherein the peak value of the low side is turned on a high side, it adds to the peak value of the high side, and the addition result is output as the reproduction signal strength VPK.

The high side peak detection circuit 112a and the low side peak detection circuit 112b have each an equal circuit composition. These detection circuits have comparators 112a_1 and 112b_1, operational amplifiers 112a_2 and 112b_2, analog switches 112a_3 and 112b_3, and peak detection capacitors 112a_4 and 112b-4, respectively. According to those detection circuits, the comparator compares the voltage level on the high side or the low side with the charge potential of the peak detection capacitor. When the former is higher than the latter, an analog switch turns on, so that the peak detection capacitor is charged by the former. On the other hands, when the voltage level on the high side or the low side is lower than the charge potential of the peak detection capacitor, the analog switch turns off, so that the charge potential of the peak detection capacitor is maintained. As a result, the peak value of the voltage level on the high side or the low side is detected as the charge potential of the peak detection capacitor.

In the addition circuit 112c, the peak value of the voltage level on the low side is added to the peak value of the voltage level on the high side with the polarity reversed. At the addition, the prescribed potential VREF given by the disk controller 107 of FIG. 1 is added too. The reproduction signal strength VPK output from the addition circuit 112c through such addition corresponds to the result of all wave rectification and smoothing applied to the reproduction signal on the prescribed potential VREF.

The flying height adjustment circuit 110 illustrated in FIG. 5 has: comparison means 113 for comparing the reproduction signal strength VPK output from the signal detection means 112 with the reference strength VSET where the reproduction signal should have when the flying height of the head slider 104 is the reference flying height; flying height control means 114 to generate the flying height adjustment signal for the flying height adjustment mechanism 103 based on the comparison result in the comparison means 113 and to output. The comparison means 113 corresponds to one example of the comparator in a basic form of the control circuit and the information storage device as mentioned above. The flying height control means 114 corresponds to one example of the flying height control section in those basic forms.

According to the present embodiment, the reference strength VSET of a fixed value is input to the comparison means 113 by the disk controller 107 of FIG. 1. In the comparison means 113, the reference strength VSET is subtracted from the reproduction signal strength VPK, the signal strength difference that is the difference of both is computed, and the signal strength difference is transferred to the flying height control means 114.

In the flying height control means 114, when the signal strength difference is positive, there is generated the flying height adjustment signal in which only the voltage corresponding to the signal strength difference is subtracted from the flying height adjustment signal of the default corresponding to a reference flying height on the design. When the signal strength difference is negative, there is generated the flying height adjustment signal in which only the voltage corresponding to the signal strength difference is added to the flying height adjustment signal of the default.

The Flying height adjustment circuit 110 has flying height correction means 115 that corrects the flying height adjustment signal generated like this by the flying height control means 114 according to the discrimination result in the polarity discrimination circuit 106.

When the polarity discriminated with the polarity discrimination circuit 106 is a positive polarity corresponding to the demagnetization non-generation, the flying height correction means 115 transfers the flying height adjustment signal generated by the flying height control means 114 to the low frequency superposed circuit 105 as it is. Moreover, when the polarity discriminated with the polarity discrimination circuit 106 is a negative polarity corresponding to the demagnetization non-generation, the flying height correction means 115 transfers the flying height adjustment signal corrected in the direction where the demagnetization is evaded to the low frequency overlay circuit 105 in such a way that the flying height correction means 115 subtracts only a prescribed voltage from the flying height adjustment signal generated by the flying height control means 114.

According to the present embodiment, the flying height from the magnetic disk 101 of the head slider 104 is maintained with the flying height adjustment circuit 110 in the tolerance that contains the reference flying height, and in addition the demagnetization is evaded by the correction with the flying height correction means 115. Thus, the according to the information storage device 100 of the present embodiment, there is executed the control of the flying height in which demagnetization is evaded, and it is possible to perform record and reproduction of information excellently.

Next, there will be explained a second embodiment of the control circuit and the information storage device.

The second embodiment is different from the first embodiment in the composition of the flying height adjustment circuit and the operation of the disc controller. In the following, there will be explained the second embodiment paying attention to the difference point.

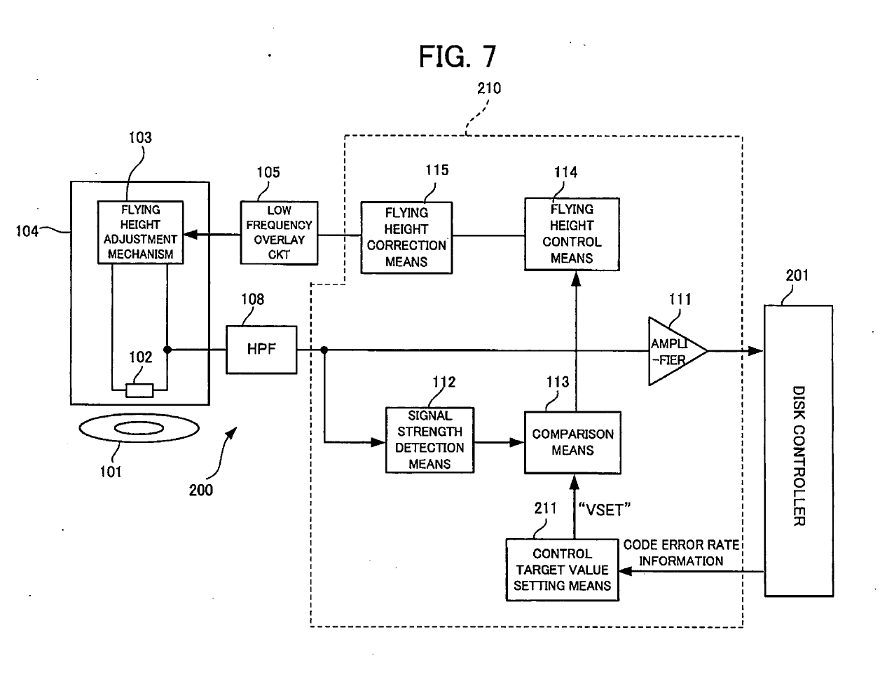

FIG. 7 is a typical block diagram of a second embodiment of a control circuit and an information storage device.

The information storage device 200 of the second embodiment is provided with circuits equal to the low frequency circuit 120 and the polarity discrimination circuit 106 of FIG. 1, but illustration is omitted in FIG. 7 for the purpose of simplification of figure. In FIG. 7, the same parts are denoted by the same reference numbers as those of FIG. 5, and redundant description for the same parts will be omitted.

In the flying height adjustment circuit 210 of the information storage device 200 of FIG. 7, the reference voltage VSET that is the fixed value in the flying height adjustment circuit 110 in the first embodiment is computed based on the code error rate in the reproduction signal. The disk controller 201 computes the code error rate in the reproduction signal upon receipt of the reproduction signal through the flying height adjustment circuit 210, and transmits code error rate information that indicates the computation result to the flying height adjustment circuit 210. The flying height adjustment circuit 210 has control target value setting means 211 that determines the reference voltage VSET using the code error rate information sent from the disk controller 201 and set it to the comparison means 113. According to the present embodiment, the reference voltage VSET is updated properly based on the code error rate of the reproduction signal, so that the flying height is controlled with greater accuracy. According to the present embodiment, the combination of the flying height adjustment circuit 210 and the disk controller 201 corresponds to the second embodiment of the control circuit, and also corresponds to one example of the control circuit in a basic form of the information storage device. The disk controller 201 corresponds to one example of the signal processing circuit in application form of the control circuit. The control target value setting means 211 corresponds to one example of the control target value setting section in the application form.

Hereinafter, there will be explained renewal processing of a reference voltage VSET based on a code error rate of a reproduction signal in the present embodiment.

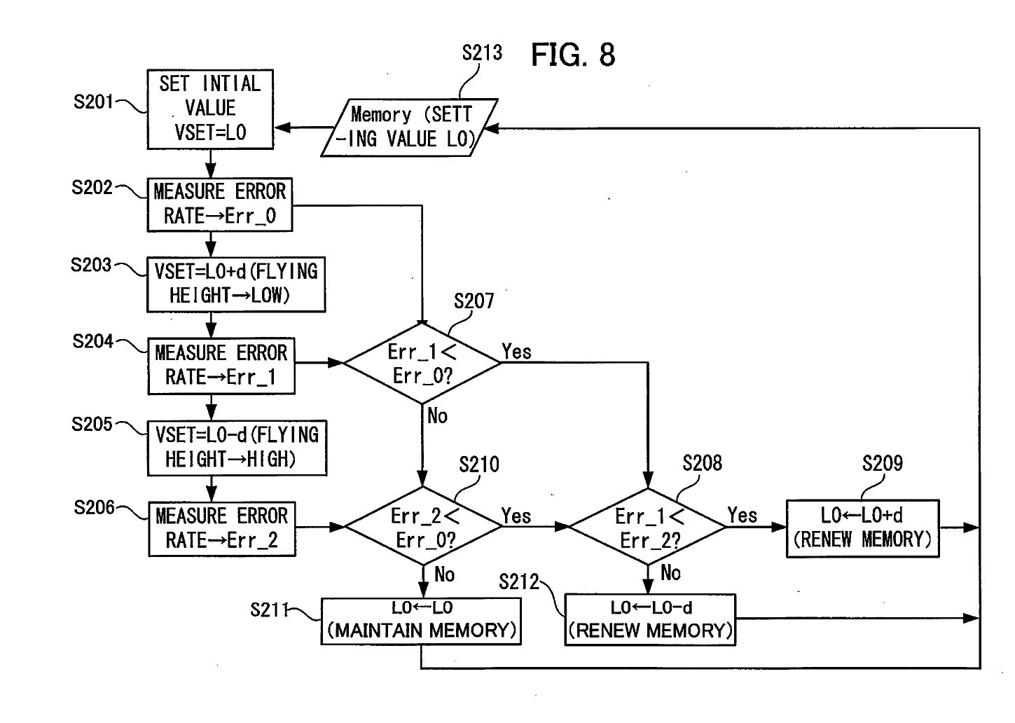

FIG. 8 is a flowchart useful for understanding renewal processing of a reference voltage VSET based on a code error rate of a reproduction signal.

The processing illustrated in the flow chart of FIG. 8 is executed at prescribed intervals repeatedly at the time of reproduction of information.

The reproduction of information is executed by using the reference voltage L0 (initial voltage) stored in a prescribed memory at the starting time, when the processing illustrated in the flow chart starts (step S201).

According to the present embodiment, information is recorded on the magnetic disk 101 while added for a prescribed error detecting code. When the reproduction signal is obtained in step S201, a code error rate Err_0 of the reproduction signal is computed by using the error detecting code in the reproduction signal in the disk controller 201 (step S202). Subsequently, the reproduction of information is executed in the state that the flying height is controlled, using the first reference voltage L0+d wherein L0 denotes the initial voltage, and d denotes a prescribed voltage, so that the head slider 104 approaches the magnetic disk 101 by the prescribed voltage d, (step S203), and a code error rate Err_1 in the reproduction signal thus obtained through the reproduction is computed the in disk controller 201 (step S204). In addition, the reproduction of information is executed in the state that the flying height is controlled, using the second reference voltage L0−d in which the prescribed voltage d is subtracted from the initial voltage L0, so that the head slider 104 may keep away from the magnetic disk 101 by the prescribed voltage d (step S205), and a code error rate Err_2 in the reproduction signal thus obtained through the reproduction is computed in the disk controller 201 (step S206). Three kinds of code error rates obtained through a series of processing from step S201 to step S206 are transferred from the disk controller 201 to the control target value setting means 211 of FIG. 7.

In the control target value setting means 211, first of all, it is judged whether the code error rate Err_1 obtained by the first reference voltage L0+d is smaller than the code error rate Err_0 obtained by the initial voltage L0 (step S207). When it is judged that the former is smaller than the latter (Yes judgment in step S207), it is judged whether the code error rate Err_1 obtained by the first reference voltage L0+d is smaller than the code error rate Err_2 obtained by the second reference voltage L0−d (step S208). In the judgment, when it is judged that the former is smaller than the latter (Yes judgment in step S208), the reference voltage VSET that is L0 in an initial voltage is updated to the first reference voltage L0+d, and the reference voltage VSET after updates is transferred to the comparison means 113 of FIG. 7 (step S209).

In step S207, when it is judged that error rate Err_1 that is obtaining by the first reference voltage L0+d is or more than the code error rate Err_0 obtained by the initial voltage L0 (No judgment in step S207), it is judged whether the code error rate Err_2 obtained by the second reference voltage L0−d is smaller than the code error rate Err_0 obtained by the initial voltage L0 (step S210). In this judgment, when it is judged that the former is more than the latter (No judgment in step S210), the reference voltage VSET is maintained in an initial voltage L0 and the reference voltage VSET is transferred to the comparison means 113 of FIG. 7 (step S211). Moreover, in step S210, when it is judged that the former is smaller than the latter (Yes judgment in step S210), the judgment in step S208 is carried out.

In the judgment of step S208, when it is judged that the error rate Err_1 obtained by the first reference voltage L0+d is more than the code error rate Err_2 obtained by the second reference voltage L0−d (No judgment in step S208), the reference voltage VSET that is an initial voltage L0 is updated to the second reference voltage L0−d, and the updated reference voltage VSET is transferred to the comparison means 113 of FIG. 7 (step S212).

When renewal or maintenance of the reference voltage VSET is carried out in accordance with a series of processing from step S207 to step S212, the initial voltage L0 stored in the memory is rewritten in the reference voltage that is finally set by such a series of processing (step S213).

The processing of the flowchart that is explained above is processing of setting one with the smallest code error rate of the above-mentioned three kinds of reference voltages as the reference voltage VSET used to reproduce information. According to the present embodiment, such processing is executed at prescribed intervals repeatedly at the time of reproduction of information, so that the reference voltage used to reproduce information is regularly updated in such a way that the code error rate may become small. This feature makes it possible to control the flying height with greater accuracy.

Also in the second embodiment as explained above, in a similar fashion to that of the first embodiment, the flying height control mechanism 103, which controls the flying height from the magnetic disk 101 of the head slider 104, executes the control that evades the demagnetization. This feature makes it possible to perform the record and the reproduction of information excellently.

Next, there will be explained the third embodiment of the control circuit and the information storage device.

The third embodiment is different from the first embodiment in the structure of the flying height adjustment circuit. In the following, there will be explained the third embodiment paying attention to thus difference point.

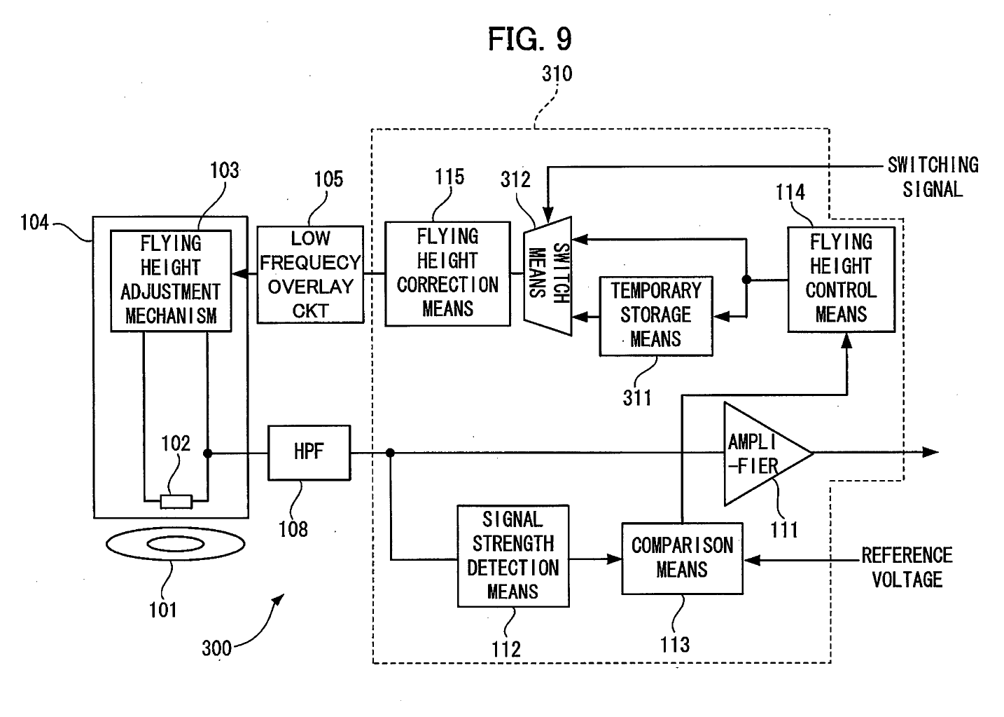

FIG. 9 is a typical block diagram of the third embodiment of the control circuit and the information storage device.

The information storage device 300 of the third embodiment is provided with circuits equal to the low frequency circuit 120 and the polarity discrimination circuit 106 of FIG. 1, but illustration is omitted in FIG. 9 for the purpose of simplification of figure. In FIG. 9, the same parts are denoted by the same reference numbers as those of FIG. 5, and redundant description for the same parts will be omitted.

In the flying height adjustment circuit 310 of the information storage device 300 of FIG. 9, an adjustment of the flying height, which is executed always on a real-time basis with the flying height adjustment circuit 110 of the first embodiment, is carried out by switching properly between an adjustment of the real-time and a simple adjustment that uses the existing flying height adjustment signal used in the past adjustment. The flying height adjustment circuit 310 corresponds to the third embodiment of the control circuit, and corresponds also to one example of the control circuit in a basic form of the information storage device.

The flying height adjustment circuit 310 has: temporary storage means 311 for temporarily store the flying height adjustment signal determined by the flying height control means 114; and switch means 312 responsive to a switching signal from the disk controller 107 to switch the flying height adjustment signal to be transferred to flying height correction means 115 between a real-time flying height adjustment signal which is determined by flying height control means 114 on a real time basis and an existing flying height adjustment signal that is stored in the temporary storage means 311. A combination of the temporary storage means 311 and the switch means 312 corresponds to an example of the switching section in the application form of the control circuit. The temporary storage means 311 corresponds to an example of the temporary storage area in the application form of the control circuit.

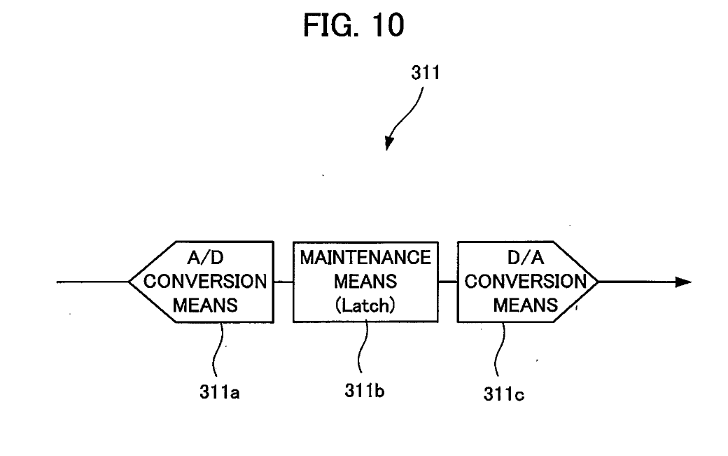

FIG. 10 is a view illustrating details of temporary storage means 311.

As illustrated in FIG. 10, the temporary storage means 311 is composed of: A/D conversion means 311a to convert the flying height adjustment signal as the analog voltage value determined in the flying height control means 114 into a digital signal; maintenance means 311b to maintain the flying height adjustment signal converted into a digital signal; and D/A conversion means 311c to convert the maintained flying height adjustment signal into an analog flying height adjustment signal. Thus, according to the present embodiment, the existing flying height adjustment signal is stored in form of the digital signal. However, it is acceptable that the temporary storage area in the application form is one which stores an existing flying height adjustment signal by the charge to the capacitor for instance as an analog voltage value, not restricted to the present embodiment.

The operation of the information storage device 300 of FIG. 9 is the same as the operation of the information storage device 100 in the first embodiment in the state that a real-time flying height adjustment signal is set to be used as a flying height adjustment signal transferred to the flying height correction means 115 according to the switch means 312. And, the memory content of the temporary storage means 311 is updated at any time at this state by the real-time flying height adjustment signal.

On the other hand, when the switch means 312 provides such setting that the existing flying height adjustment signal that is stored in the temporary storage means 311 is used as a flying height adjustment signal to be transferred to the flying height correction means 115, the signal strength detection means 112, the comparison means 113, and the flying height control means 114 stop operating. Therefore, at that time, the memory content of the temporary storage means 311 is maintained by the switch means 312 like the memory content immediately before the operational state of the information storage device 300 is switched to the state that an existing flying height adjustment signal is used.

According to the present embodiment, the disk controller 107 inputs to the switch means 312, at the time when information is recorded, the switching signal that switches the operational state to the state that an existing flying height adjustment signal is used, and inputs to the switch means 312, at the time when information is reproduced, the switch signal that switches the operational state to the state that a real-time flying height adjustment signal is used.

In addition, the disk controller 107 inputs to the switch means 312, at the time when the track where the recording and reproducing head 102 reproduces information is changed, the switch signal that switches the operational state to the state that a real-time flying height adjustment signal is used immediately after the change. And after prescribed time passes, the disk controller 107 inputs to the switch means 312 the switch signal that switches the operational state to the state that an existing flying height adjustment signal is used. This is based on the experience rule that the substantial change doesn't appear to the flying height of the recording and reproducing head 102 too much when information on the same track is reproduced though relatively large change appears to the flying height of the recording and reproducing head 102 when the track where information is reproduced changes.

According to the present embodiment, the efficiency improvement of processing is attempted by stopping a real-time control to the flying height in the minimum requirement like this.

Also in the third embodiment as explained above, in a similar fashion to that of the first embodiment and the second embodiment, the flying height control mechanism 103, which controls the flying height from the magnetic disk 101 of the head slider 104, executes the control that evades the demagnetization. This feature makes it possible to perform the record and the reproduction of information excellently.

Next, there will be explained the fourth embodiment of the control circuit and the information storage device.

The fourth embodiment is different from the first embodiment in the structure of the flying height adjustment circuit. In the following, there will be explained the fourth embodiment paying attention to thus difference point.

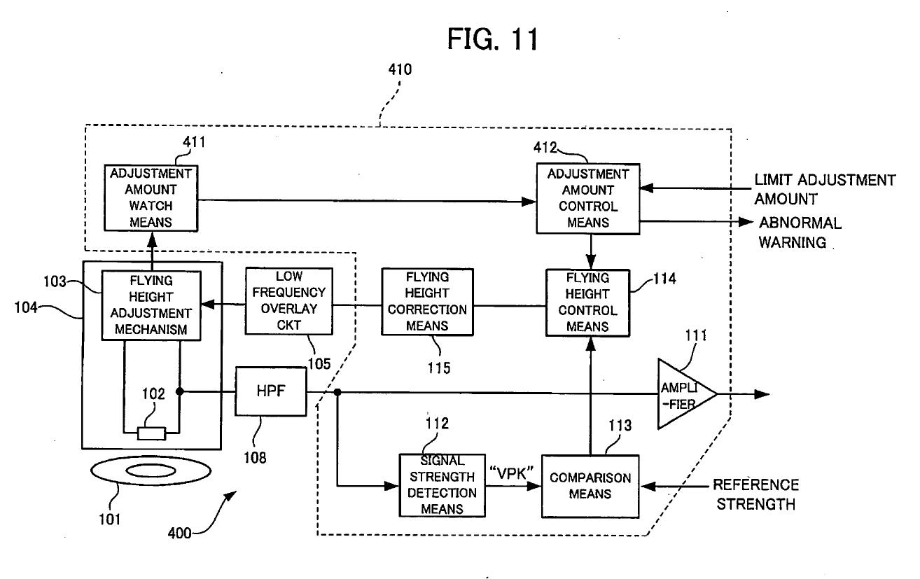

FIG. 11 is a typical block diagram of a fourth embodiment of a control circuit and an information storage device.

The information storage device 400 of the fourth embodiment is provided with circuits equal to the low frequency circuit 120 and the polarity discrimination circuit 106 of FIG. 1, but illustration is omitted in FIG. 11 for the purpose of simplification of the figure. In FIG. 11, the same parts are denoted by the same reference numbers as those of FIG. 5, and redundant description for the same parts will be omitted.

For instance, when the recording and reproducing head 102 is deteriorated, it is likely to fall into the situation that strength of the reproduction signal doesn't reach standard strength VSET no matter how the recording and reproducing head 102 is brought close to the magnetic disk 101. For this case, the control of the flying height becomes useless. According to the present embodiment, the amount of the adjustment in the flying height adjustment mechanism 103 to the flying height is always observed. And, the amount of the adjustment is limited below a prescribed amount of the limit adjustment, and when the amount of the adjustment reaches the amount of the limit adjustment, an abnormality warning that notifies the deterioration of the recording and reproducing head 102 is sent to the disk controller 107.

The flying height adjustment circuit 410 of the information storage device 400 of the present embodiment has adjustment amount watch means 411 for watching the adjustment amount for the flying height, and adjustment amount limitation means 412 for limiting the adjustment amount below the limit adjustment amount and for sending the above-mentioned abnormality warning. The flying height adjustment circuit 410 corresponds to the fourth embodiment of the control circuit, and also corresponds to the example of the control circuit in the basic form of the information storage device. The adjustment amount watch means 411 corresponds to the example of the flying height adjustment mechanism voltage monitoring section in the application form of the control circuit. The adjustment amount limitation means 412 corresponds to one example of the flying height adjustment voltage control section in the application form.

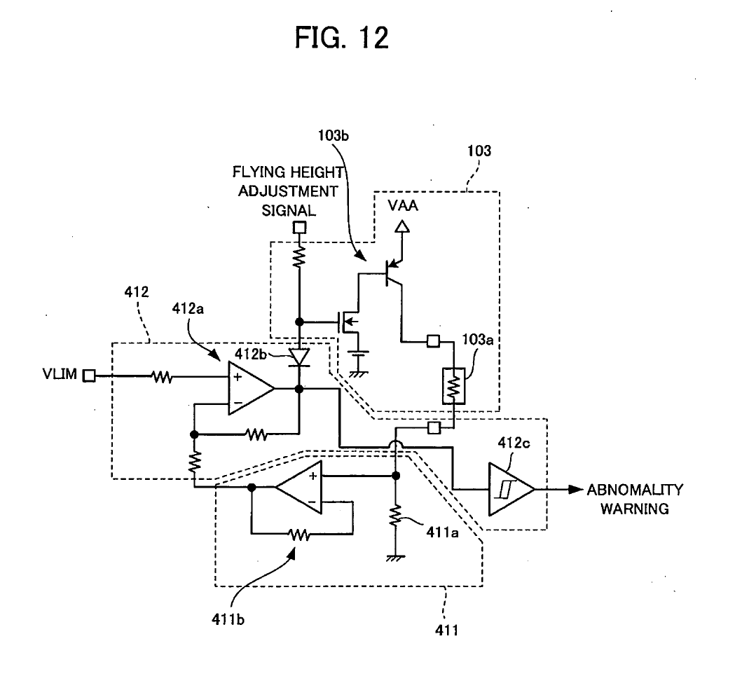

FIG. 12 is a circuit diagram of the adjustment amount watch means 411 and the adjustment amount limitation means 412.

FIG. 12 also illustrates the circuit diagram of the flying height control mechanism 103. As mentioned above, the flying height control mechanism 103 is composed of a heater 103a for heating, and a supply circuit 103b that supplies the current to the heater 103a. When the flying height adjustment signal that is the voltage signal indicative of the magnitude of the current supplied to the heater 103a is input from the flying height adjustment circuit 110 to the supply circuit 103b, the supply circuit 103b supplies the current of the magnitude corresponding to the magnitude of the flying height adjustment signal to the heater 103a. The magnitude of the current supplied to the heater 103a indicates the amount of the adjustment to the flying height of the head slider 104, that is, the flying height of the recording and reproducing head 102 as it is. According to the present embodiment, the adjustment amount watch means 411 watches the magnitude of this current as an amount of the adjustment for the flying height.

The adjustment amount watch means 411 has a watch resistance 411a through which a current supplied to heater 103a flows, so that a voltage (watch voltage) corresponding to the current value generates, and a buffer circuit 411b that inputs the watch voltage to the adjustment amount limitation means 412 with the high impedance.

The adjustment amount limitation means 412 has: a comparison circuit 412a that compares a watch voltage input from the adjustment amount watch means 411 with a limit voltage VLIM that will be generated by the watch resistance 411a when the current that corresponds to the above-mentioned amount of limit adjustment is supplied to the heater 103a, and outputs a prescribed low voltage when the former is less than latter, and outputs a high voltage equal to the limit voltage VLIM when the former is not less than the latter; a diode 412b arranged between an input section of the flying height adjustment signal of the flying height control mechanism 103 and an output section of the comparison circuit 412a; and a warning circuit 412c that sends the abnormality warning to the disk controller 107 when the output of the comparison circuit 412a changes from the low voltage to the high voltage. Incidentally, according to the present embodiment, the limit voltage VLIM is generated with the disk controller 107 and input.

When the watch voltage is less than the limit voltage VLIM, the output of the comparison circuit 412a will become a low voltage and the diode 412b becomes a reverse bias. Thus, the flying height adjustment signal is input to the flying height control mechanism 103 as it is, so that the flying height is adjusted in accordance with the flying height adjustment signal.

On the other hand, when the watch voltage reaches the limit voltage VLIM, the output of the comparison circuit 412a becomes a high voltage, and the diode 412b becomes a forward bias, so that the limit voltage VLIM is input to the flying height control mechanism 103. Thus, the flying height becomes the amount of the limit adjustment corresponding to the limit voltage VLIM. While the output of comparison circuit 412a is a high voltage, this state is maintained. Therefore, it is limited so that the amount of the adjustment to the flying height should not exceed the amount of the limit adjustment. According to the present embodiment, when the watch voltage reaches the limit voltage VLIM, an abnormality warning is sent with the warning circuit 412c. Thus, the user can recognize the deterioration of the recording and reproducing head 102.

Also in the fourth embodiment as explained above, in a similar fashion to that of the first embodiment to the third embodiment, the flying height control mechanism 103, which controls the flying height from the magnetic disk 101 of the head slider 104, executes the control that evades the demagnetization. This feature makes it possible to perform the record and the reproduction of information excellently.

Next, there will be explained the fifth embodiment of the control circuit and the information storage device.

The fifth embodiment is different from the first embodiment in the structure of the head slider and the flying height adjustment circuit. In the following, there will be explained the fifth embodiment paying attention to thus difference point.

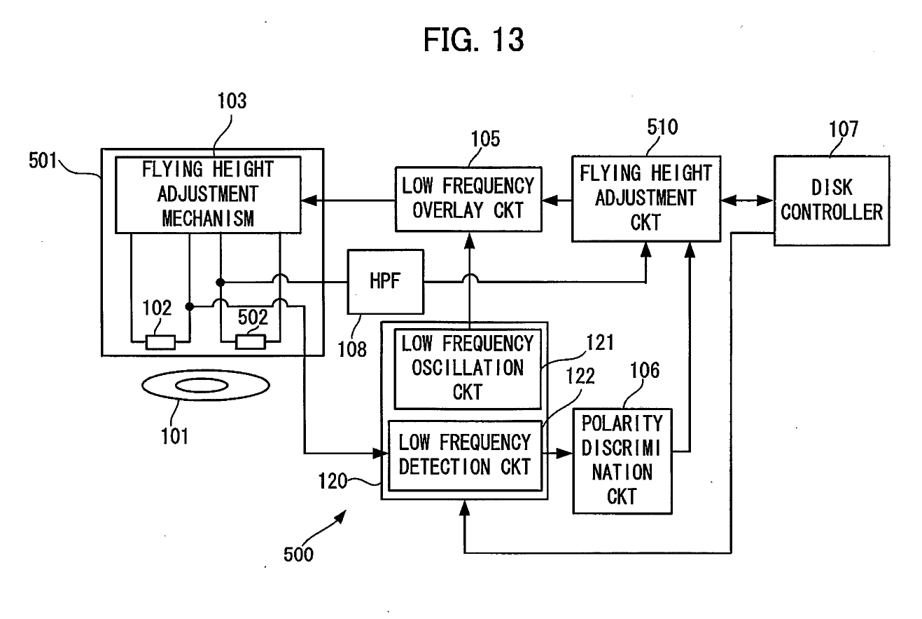

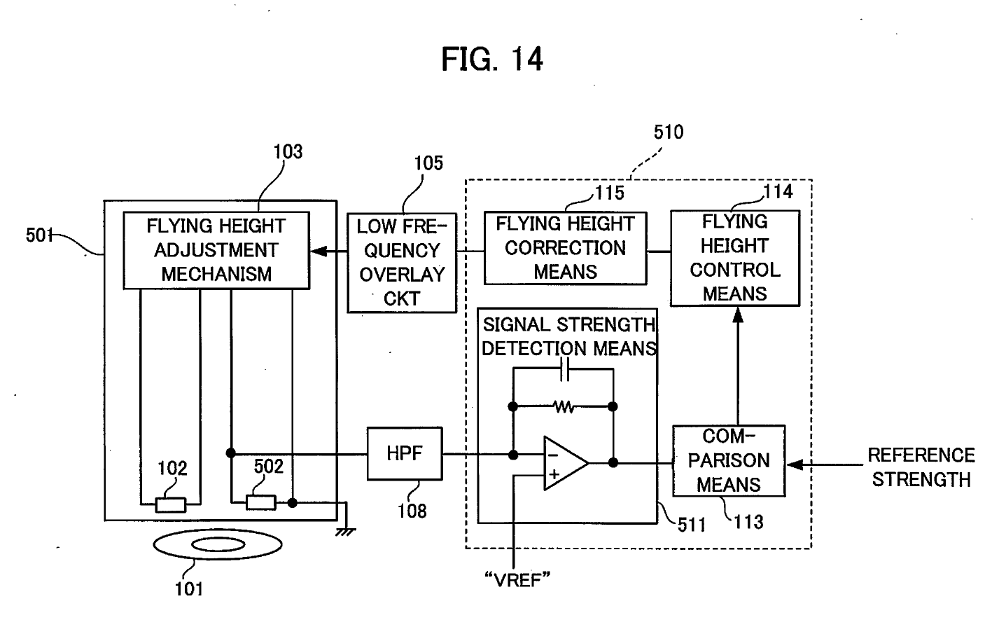

FIG. 13 is a typical block diagram of the fifth embodiment of the control circuit and the information storage device. FIG. 14 is a view illustrating details of the flying height adjustment circuit.

In FIG. 13, the same parts are denoted by the same reference numbers as those of FIG. 1, and redundant description for the same parts will be omitted. In FIG. 14, the same parts are denoted by the same reference numbers as those of FIG. 5, and redundant description for the same parts will be omitted.

A head slider 501 of an information storage device 500 according to the present embodiment has a flying height adjustment head 502 used to adjust the flying height to the magnetic disk 101 of the recording and reproducing head 102 in addition to the recording and reproducing head 102 for performing record and reproduction of the information for the recording and reproducing head 102. The flying height adjustment head 502 is arranged near the recording and reproducing head 102 so as to receive the same magnetic field as the magnetic field that recording and reproducing head 102 receives from the magnetic disk 101 when information is reproduced. The flying height of the flying height adjustment head 502 can be identified to the flying height of the head slider 501, that is, the flying height of the recording and reproducing head 102. The head slider 501 corresponds to one example of the head slider in the basic form of the control circuit and the information storage device.

As mentioned above, the recording and reproducing head 102 consists of the recording head that records information and the reproducing head that reproduces information. According to the present embodiment, the flying height adjustment head 502 is equal to the reproducing head in the recording and reproducing head 102. These heads possess the characteristic that own low efficiency becomes low efficiency corresponding to a surrounding magnetic field, and are the one to detect the magnetic field based on own low efficiency.

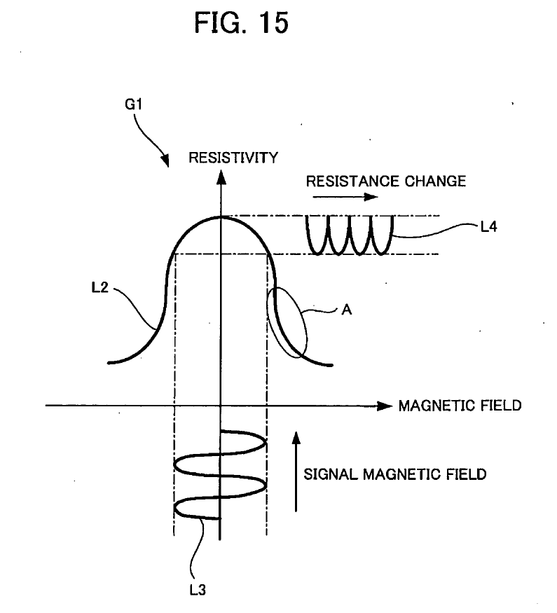

FIG. 15 is a typical block diagram useful for understanding variation of resistivity in the flying height adjustment head 502 to the magnetic field.

FIG. 15 illustrates graph G1 where a vertical axis denotes a low efficiency of the flying height adjustment head 502, and a horizontal axis denotes the magnetic field. The graph G1 illustrates line L2 that indicates the change to the magnetic field of the resistivity of the flying height adjustment head 502. As illustrated by line L2, the resistivity of the flying height adjustment head 502 becomes the maximum value when the magnetic field is “0”, and decreases as the magnetic field increases in the direction of the plus or the direction of the minus. Moreover, the state of a decrease in the resistivity is the same regardless of the polarity of the magnetic field.

The reproducing head on the recording and reproducing head 102 also has the same characteristic as the characteristic of the flying height adjustment head 502. Applied to this reproducing head is a bias magnetic field where the resistivity becomes a resistivity in part A that has the inclination of lower right in line L2. Here, information in the magnetic disk 101 is recorded by arranging two kinds of magnetizations of a magnetization that generates the magnetic field of a positive polarity and a magnetization that generates the magnetic field of a negative polarity. Because the reproducing head is used while the bias magnetic field is applied thereto, the reproducing head causes the magnetic field of a positive polarity where the magnetization of the former is generated to bring the decline in the resistivity, and causes the magnetic field of a negative polarity where the magnetization of the latter is generated to bring the rise in the resistivity. The constant current conducts through the reproducing head, and the change in such a resistivity is detected as a change in the voltage. For the reproducing head of the recording and reproducing head 102, information on the magnetic disk 101 is reproduced like this.

On the other hand, as for the flying height adjustment head 502 the bias magnetic field is used while non-applied.

As a result, the magnetic field of a positive polarity and the magnetic field of a negative polarity both cause the decrease in the resistivity.

For instance, in the magnetic disk 101, if the magnetization that generates the magnetic field of a positive polarity and the magnetization that generates the magnetic field of a negative polarity is alternately arranged, the magnetic field caused by the array of such a magnetization becomes a magnetic field where the polarity reverses alternately as illustrated by a sine wave of line L3 of FIG. 15. The change in the resistivity by the reproducing head due to such a magnetic field is a change of the sine wave that centers on the resistivity corresponding to the bias magnetic field, and the reproduction signal obtained by the reproducing head at that time becomes a sine wave signal, too. According to the first embodiment, all wave rectification and smoothing to the reproduction signal are executed by using the signal strength detection means 112 illustrated in FIG. 6 to determine strength of such a reproduction signal.

According to the present embodiment, strength of the reproduction signal is determined by using the reproduction signal obtained by the flying height adjustment head 502, but not the reproduction signal obtained by the reproducing head of the recording and reproducing head 102. For instance, the sine wave magnetic field that is indicated by a sine wave line L3 of FIG. 15 becomes a change that corresponds to the shape of waves in which a plus side of the sine wave line L3 is folded into a minus side, as indicated by the upper right wave line L4 in the figure, on the resistivity of the flying height adjustment head 502. As a result, a reproduction signal obtained by the flying height adjustment head 502 becomes a signal equal to the one in which all wave rectification is applied to the reproduction signal obtained by the reproducing head, even if any processing is not applied to the reproduction signal.

As illustrated in FIG. 14, after the low frequency detection signal is excluded with the high-pass filter 108, the reproduction signal obtained by the flying height adjustment head 502 is input to the signal strength detection means 511 of the flying height adjustment circuit 510. The flying height adjustment circuit 510 corresponds to the fifth embodiment of the control circuit, and also corresponds to one example of the control circuit in a basic form of the information storage device. Moreover, the signal strength detection means 511 corresponds to one example of the signal strength detection section in a basic form of the control circuit.

According to the present embodiment, as mentioned above, since the reproduction signal input to the signal strength detection means 511 is a signal that is subjected to all wave rectification, the signal strength detection means 511 performs simply the smoothing with a capacitor and the addition of the prescribed potential VREF used is the first embodiment. In the signal strength detection means 511, it is possible to obtain the reproduction signal strength equal to the reproduction signal strength VPK in the first embodiment by such easy processing. The reproduction signal strength is input to the comparison means 113, so that the flying height of the head slider 501 is adjusted by the same processing as the adjustment processing of the flying height in the first embodiment.

Also in the fifth embodiment as explained above, in a similar fashion to that of the first embodiment to the fourth embodiment, the flying height control mechanism 103, which controls the flying height from the magnetic disk 101 of the head slider 501, executes the control that evades the demagnetization. This feature makes it possible to perform the record and the reproduction of information excellently.

According to the explanation for the individual embodiments of the present invention as mentioned above, as an embodiment of the signal strength detection section referred to in the present invention, there is disclosed the signal strength detection means in which the one that all wave rectification and smoothing are applied to the reproduction signal is obtained in form of the strength VPK of the reproduction signal (reproduction signal strength). However, the signal strength detection section referred to in the present invention is not restricted to the signal strength detection means disclosed on the embodiments. It is acceptable that the signal strength detection section is one in which the one that the half wave rectification and smoothing are applied to the reproduction signal is obtained in form of the strength of the reproduction signal, or alternatively, the mean value of the reproduction signal is obtained in form of the strength of the reproduction signal.

According to the control circuit in the embodiment as described above, the flying height control mechanism controls the flying height of the head slider, that is, the flying height of the recording and reproduction head to the reference flying height in accordance with the control of the flying height control section. Moreover, according to the control circuit in the embodiment as described above, the low frequency is superimposed to the head slider at the same time as this controlling. What is meant by “the low frequency is superimposed to the head slider” referred to above is that the low frequency overlay signal is superimposed to the control signal of the flying height so that the flying height of the head slider changes in a prescribed low frequency. The flying height of the recording and reproducing head changes gradually basically by this overlay around the reference flying height, so that the signal strength of the reproduction signal changes gradually. What is meant by “low frequency overlay signal where the low frequency is superposed” referred to above is the former low frequency overlay signal superimposed to the control signal of the flying height. What is meant by “low frequency overlay signal obtained from a reproduction signal” referred to above is the low frequency overlay signal extracted from the reproduction signal that has the change as mentioned above. According to the control circuit in the embodiment as described above, the limit flying height judgment section compares the former low frequency overlay signal superimposed to the control signal of the flying height with the low frequency overlay signals extracted from the reproduction signal. In the event that the recording and reproducing head is away enough from the recording medium such as magnetic disks, so that the demagnetization is not caused, the signal strength of the reproduction signal increases if the recording and reproducing head approaches the recording medium, and the signal strength of the reproduction signal decreases if the recording and reproducing head goes away from the recording medium. On the other hand, in the event that the recording and reproducing head approaches the recording medium such as magnetic disks too much, so that the demagnetization is caused, the signal strength of the reproduction signal decreases if the recording and reproducing head approaches the recording medium, and the signal strength of the reproduction signal increases if the recording and reproducing head goes away from the recording medium. In a word, between a case where the demagnetization is not caused and a case where the demagnetization is caused, the change mutually becomes opposite in the former low frequency overlay signal and the low frequency overlay signal extracted. According to the control circuit in the embodiment as described above, the limit flying height judgment section can judge whether the flying height of the head slider falls below the limit flying height that is the lower bound to be able to control the flying height in a state evading the demagnetization by detecting the reverse of a polarity for instance. In the event that the limit flying height judgment section judges that the flying height of the head slider falls below the limit flying height, for instance, the flying height control section suitably corrects the control signal so that the flying height of the head slider becomes not less than the limit flying height. Such an easy operation makes it possible to perform the control for the flying height in which the demagnetization is evaded. In effect, according to the control circuit in the embodiment as described above, it is possible to cause the flying height control mechanism that controls the flying height from the recording medium of the head slider to execute a control evading the demagnetization.

According to the information storage device in the embodiment as described above, the flying height of the head slider to the recording medium, that is, the flying height of the recording and reproducing head from the recording medium is controlled to evade the demagnetization, and thus, it is possible to perform recording and reproduction of information excellently.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control circuit for flying height of a head slider having a flying height control mechanism and a recording and reproducing head, the control circuit comprising:
a signal strength detection section that detects strength of a reproduction signal of the recording and reproducing head;
a low frequency oscillation section that superimposes a low frequency to the head slider;
a limit flying height judgment section that judges whether or not a flying height of the head slider has reached a limit flying height, through comparison of a low frequency overlay signal where the low frequency is superposed to the head slider and a low frequency overlay signal obtained from a reproduction signal of the recording and reproducing head when the low frequency is superposed to the head slider;
a comparator that computes an output strength difference between a signal strength output from the signal strength detection section and a reference signal strength on a reference flying height; and
a flying height control section that receives the output strength difference from the comparator and the limit flying height from the limit flying height judgment section, and controls the flying height of the head slider with the flying height control mechanism to the reference flying height in accordance with the output strength difference and the limit flying height.

2. The control circuit according to claim 1, further comprising:
a signal processing circuit that computing code error rate information of the reproduction signal; and
a control target value setting section that receives the code error rate information and corrects the reference signal strength in accordance with the code error rate information, the corrected reference signal strength being fed to the comparator.

3. The control circuit according to claim 1, further comprising:
a switching section having a temporary storage area for storing the flying height by the flying height control section between the flying height control mechanism and the flying height control section.

4. The control circuit according to claim 1, further comprising:
a flying height adjustment mechanism voltage monitor section that monitors a voltage of the flying height adjustment mechanism, the flying height adjustment mechanism voltage monitor section being connected to the flying height control mechanism; and
a flying height adjustment mechanism voltage control section that detects the voltage input from the flying height adjustment mechanism voltage monitor section to set a permissible limit value on a control amount of the flying height control mechanism of the flying height control section.

5. The control circuit according to claim 4, wherein the flying height adjustment mechanism voltage control section sends an abnormality warning signal to a host when the control amount reaches the permissible limit value.

6. An information storage device comprising:
a head slider having a flying height control mechanism and a recording and reproducing head;
a recording medium in which information is recorded and reproduced by the recording and reproducing head; and
a control circuit comprising: a signal strength detection section that detects strength of a reproduction signal of the recording and reproducing head; a low frequency oscillation section that superimposes a low frequency to the head slider; a limit flying height judgment section that determines a limit flying height of the head slider through comparison of a low frequency overlay signal where the low frequency is superposed to the head slider and a low frequency overlay signal obtained from a reproduction signal of the recording and reproducing head when the low frequency is superposed to the head slider; a comparator that computes an output strength difference between a signal strength output from the signal strength detection section and a reference signal strength on a reference flying height; and a flying height control section that receives the output strength difference from the comparator and the limit flying height from the limit flying height judgment section, and controls the flying height of the head slider with the flying height control mechanism to the reference flying height in accordance with the output strength difference and the limit flying height.
